(19) United States
(12) Patent Application Publication
(10) Pub. No.: US 2008/0276190 A1
(43) Pub. Date: Nov. 6, 2008

(54) Customer Relationship Management System with Quicknotes

(75) Inventors: Majed Itani, San Jose, CA (US); Jacob Taylor, Santa Clara, CA (US); Ajay Gupta, Cupertino, CA (US); John Roberts, San Jose, CA (US); Clinton Oram, San Mateo, CA (US)

Correspondence Address: DLA PIPER US LLP, 2000 UNIVERSITY AVENUE, E. PALO ALTO, CA, 94303-2248, US

(73) Assignee: SugarCRM Inc., Cupertino, CA (US)

(21) Appl. No.: 12/062,506

(22) Filed: Apr. 3, 2008

Related U.S. Application Data
(60) Provisional application No. 60/921,778, filed on Apr. 3, 2007.

(51) Int. Cl. G06F 3/048

(52) U.S. Cl. 715/768; 715/809

(57) ABSTRACT

A quicknotes system and method is provided. A software-based customer relationship management system and method may include the quicknotes functionality.

### PRIORITY CLAIM

This application claims priority under 35 USC 119(e) to U.S. Provisional Patent Application Ser. No. 60/921,778 filed on Apr. 3, 2007 and entitled “Customer Relationship Management System with Quicknotes” which is incorporated herein by reference.

### FIELD

A business software system and method are described and in particular a software-based system and method for providing customer relationship management is described.

### BACKGROUND

Customer relationship management (CRM) systems and solutions are well known. For example, typical known CRM systems include Microsoft® CRM, SalesForce, a CRM product provided by SalesForce.com, Netsuite CRM, and SAP Business One CRM. However, conventional CRM systems have significant limitations that include a lack of flexibility, high costs, and a closed-source structure which is embedded into the traditional product offerings. These limitations have led to a failure rate of over 70% with traditional CRM implementations. Thus, it is desirable to provide a customer relationship management system and method that overcomes these limitations of typical CRM systems and it is to this end that the system and method are directed.

### SUMMARY

A novel business application with quicknotes is provided. In one embodiment, the business application may be a software based customer relationship management system.

### BRIEF DESCRIPTION OF THE DRAWINGS

FIG. 1A is a diagram illustrating a customer relationship management system that incorporates the various features of the invention;

FIG. 1B illustrates more details of the customer relationship management system that incorporates the various features of the invention;

FIG. 2 is a diagram illustrating an example of the user interface of the system in FIGS. 1A and 1B;

FIG. 3 illustrates an example of a quicknote on a user interface of the customer relationship management system application;

FIG. 4 is an exemplary user interface that illustrates a method for creating a new quicknote on the user interface; and

FIG. 5 illustrates an example of the user interface of a back side of a quicknote.

### DETAILED DESCRIPTION OF ONE OR MORE EMBODIMENTS

The system and method are particularly applicable to an open source customer relationship management software system and it is in this context that the system and method will be described. It will be appreciated, however, that the algorithms, data structures, processes and modules of the system and method have greater utility since these modules, algorithms, data structures and processes disclosed herein can be equally applied to other non-open source CRM systems, as well as other business software application systems as well as other database software systems. For purposes of illustration, the described system is an implementation in a customer relationship management (CRM) and groupware system. In the example below, the CRM and groupware system is the Sugar Enterprise version 4.5 commercially available from SugarCRM Inc.

The system may be implemented using a base class known as SugarBean, and a data retrieval API. A few of the methods provided in the base class include methods for building list queries, saving, and retrieving individual items. Each specific type of data creates a subclass of this base class. The base class is called SugarBean in the illustrative example that is described below. There is at least one subclass of SugarBean for each module. SugarBeans also are used for creating database tables, cleaning out database tables, loading records, loading lists, saving records, and maintaining relationships. One example of a SugarBean subclass is a Contact subclass. The Contact subclass is a simple object that fills in some member variables on the SugarBean and leverages SugarBean for much of its logic and functionality. For example, the security associated with the Contact subclass is automatically created for Contact by SugarBean that contains, among other things, the functions and processes that are shared by the other modules. Another example of a SugarBean subclass is Users which is a module that is security related and contains the list of users as well as users who should not have row level security (described below in more detail) applied to them. For this reason these modules have the bypass flag set to skip adding the right join for verifying security. The SugarCRM Sugar Professional system is a web based system with many concurrent users. Since this program contains critical data to the users, it is imperative that they have quick access to the system and their data. The most frequent activity in the program is to look at existing data.

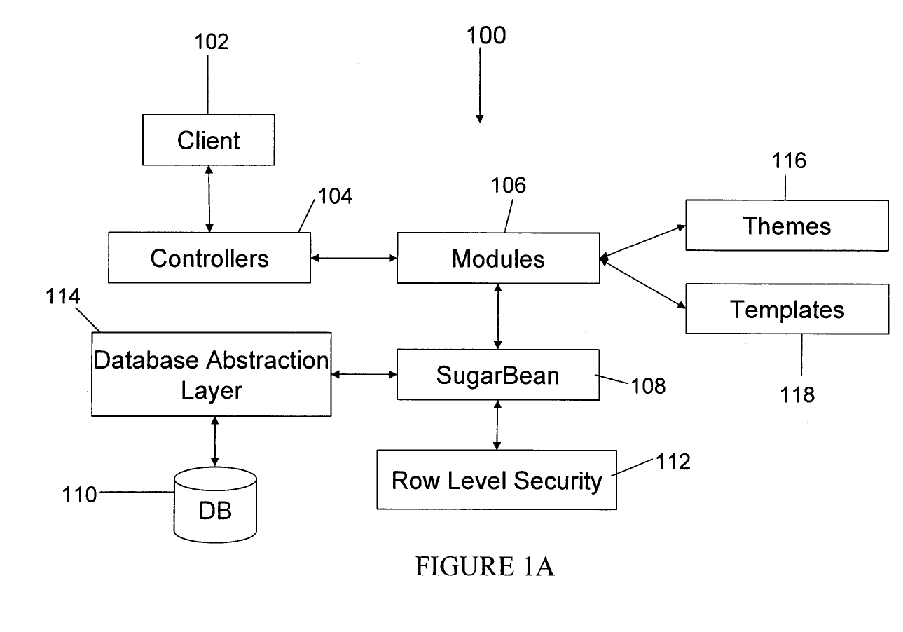

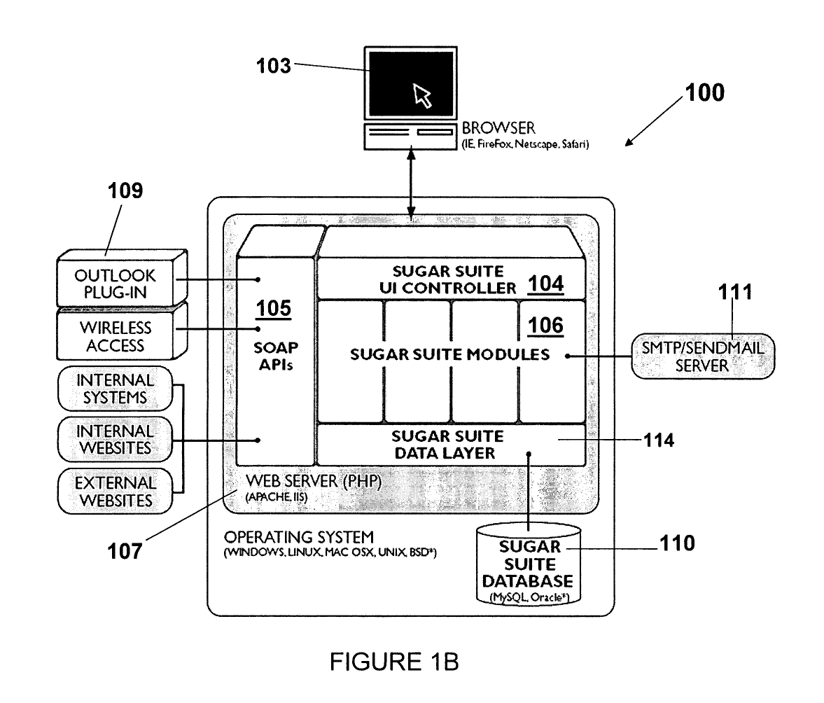

FIG. 1A is a diagram illustrating a customer relationship management (CRM) system 100 that is an example of a software-based business software application. In one embodiment, the system 100 may be implemented as a software system and the elements shown in FIGS. 1A and 1B are thus implemented as a plurality of lines of computer code that may be executed by a processor of a computer system, such as a server computer wherein the various lines of computer code are stored in a memory associated with the computer system and the system interfaces with a database 110 that stores the data associated with the system 100. The system may have one or more clients 102, such as a browser application executed on a typical computing device (a browser client session), that accesses the system over a communications network 103 such as the Internet, a cellular network, a wireless network and the like. The computing devices may include a laptop, table or desktop computer system, a PDA, a mobile phone, a portable wireless email device and the like. The client's 102 interactions with the system are managed and go through a set of one or more controllers 104. The controllers 104 are the entry-point into the system for an entity that is using the system wherein the entity may be a person who accesses the system, such as by using a browser application, a computing device or a software program that uses this entry point. The controllers 104 take care of functions and operations including, for example, session tracking, session security and user authentication. The controllers also, for each user, prepare the screen/user interface or the wrapper for the content and determine which module of the application the user is trying to access and get the requested module to process the request.

The system has one or more modules 106 that are components of application functionality and provide certain functionality to the entity accessing the system. The modules 106 of the exemplary CRM system shown in FIG. 1A may include, by way of example, a portal module, a calendar module, an activities module, a contacts module, an accounts module, a leads module, an opportunities module, a quotes module, a products module, a cases module, a bug tracker module, a documents module, an emails module, a campaigns module, a project module, an RSS module, a forecasts module, a reports module and a dashboard module. The system may include different, more or fewer modules and the systems with those other combination of modules are within the scope of the system and method. Each of these modules provides a different functionality to the users of the system so that, for example, the calendar module provides a calendaring functionality to the CRM system that is instantiated with the system. The system may also include an administration module that handles the typical administrative functions of the system. In the exemplary system shown in FIG. 1A, each module contains a subclass of a SugarBean base object 108 and each module references the SugarBean to retrieve the data from the database 110 required for display and uses certain functions and operations instantiated in the SugarBean base object.

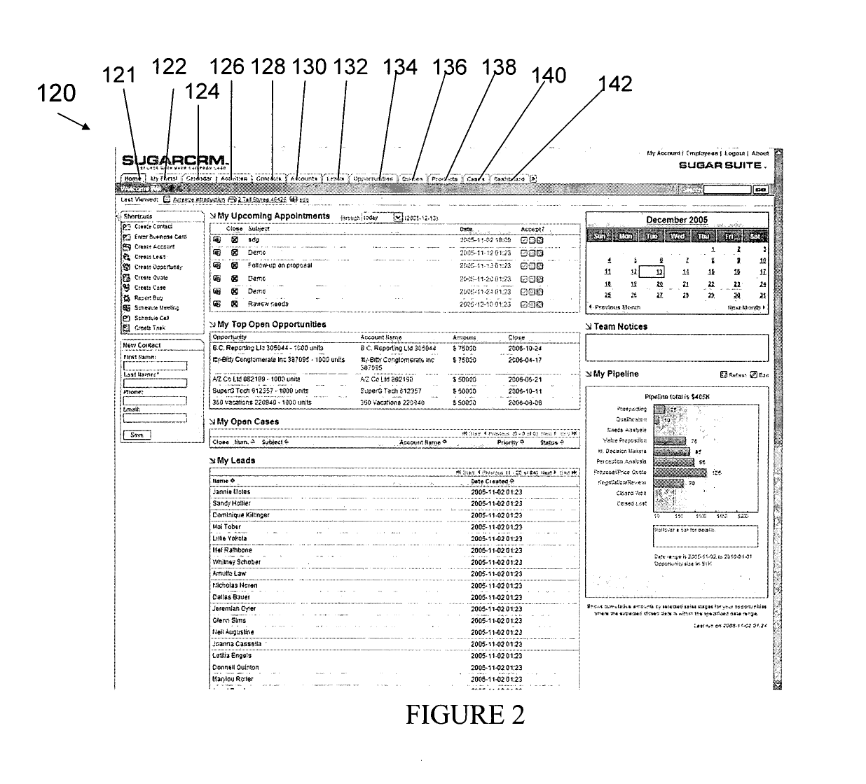

FIG. 2 is a diagram illustrating an example of the user interface 120 of the system in FIGS. 1A and 1B. The user interface may include a home tab 121 (that is selected in FIG. 2) that provides a general overview of Cases, Opportunities, Appointments, Leads, Tasks, Calendar, Team Notices, and Pipeline for the particular user since each user interface is customized for each user based on the access levels and parameters associated with that particular user. The home tab may also include shortcuts to enter various different types of data, and a quick form for new contacts. The home tab also provides a quick overview of what customer tasks and activities that the user needs to focus on today. The portal module (selected using a “My portal” tab 122), contains a series of shortcuts which can link to any web site chosen by the user that may include e-mail, forums, or any other web-based application, allowing the system to become a single user interface for multiple applications. The calendar module may be selected by a calendar tab 124 and allows the user to view scheduled activities (by day, week, month or year), such as meetings, tasks, and calls. The system also allows the user to share his/her calendar with coworkers which is a powerful tool for coordinating the daily activities. The activities module is selected using an activities tab 126 and allows the user to create or update scheduled activities, or to search for existing activities. By managing Activities within the context of an Account, Contact, Lead, Opportunity, or Case, the system allows the user to manage the myriad of calls, meetings, notes, emails and tasks that the user needs to track in order to get the job done. The tasks are for tracking any action that needs to be managed to completion by a due date, the notes allow the user to capture note information as well as upload file attachments, the calls allow the user to track phone calls with leads and customers, meetings are like calls, but also allow the user to track the location of the meeting and emails allow the user to archive sent or received email messages and to send or receive email messages.

The contacts module is accessed by a contacts tab 128 and allows the user to view a paginated contact list, or search for a contact. The user can click on a specific contact to zoom in on the detailed contact record and, from a specific contact record, the user may link to the related account, or leads, opportunities, cases, or direct reports (related contacts). Within the system, contacts are the people with whom the organization does business. As with accounts, the system allows the user to track a variety of contact information such as title, email address, and other data. Contacts are usually linked to an Account, although this is not required. The accounts module may be accessed using an accounts tab 130 and the user may view a paginated account list, or search for an account. The user can click on a specific account to zoom in on the detailed account record and, from a specific account record, the user may link to related contacts, activities, leads, opportunities, cases, or member organizations. Accounts are the companies with which the organization does business and the system allows the user to track a variety of information about an account including website, main address, number of employees and other data. Business subsidiaries can be linked to parent businesses in order to show relationships between accounts.

The leads module may be accessed by a leads tab 132 that permits the user to view a paginated list of leads, or search for a specific lead. The user can click on an individual lead to zoom in on the lead information record and, from that detailed lead record, the user can link to all related activities, and see the activity history for the lead. Leads are the people or companies with whom the organization might do business in the future. Designed to track that first point of interaction with a potential customer, leads are usually the hand off between the marketing department and the sales department. Not to be confused with a contact or account, leads can often contain incomplete or inaccurate information whereas contacts and accounts stored in Sugar Enterprise are core to many business processes that require accurate data. Leads are typically fed into the Sugar Enterprise stem automatically from your website, trade show lists or other methods. However, the user can also directly enter leads into Sugar Enterprise manually.

The opportunities module is accessed by an opportunities tab 134 and permits the user to view a paginated list of opportunities, or search for a specific opportunity. The user can click on an individual opportunity to zoom in on the opportunity information record and, from that detailed opportunity record, the user can link to all related activities, see the activity history for the opportunity, and link to related leads and contacts. Opportunities track the process of selling a good or service to a potential customer. Once a selling process has commenced with a lead, a lead should be converted into a contact and possibly also an account for example among other items. Opportunities help the user manage the selling process by tracking attributes such as sales stages, probability of close, deal amount and other information. The quotes module may be accessed by a quotes tab 136 and permits the user to view a paginated list of customer quotes, or search for a specific quote. The user can click on an individual quote to zoom in on the detailed quote information. A quote is formed by referencing product and pricing from a catalog of products you may create. A presentation quality Portable Document Format (PDF) representation of the quote may be created to fax or email to a client. Quotes may be associated with, for example, Accounts, Contacts, or Opportunities among other modules in the system and the system is not limited to a quote being associated with any particular set of modules.

The products module may be accessed by a products tab 138 and permits the user to view a paginated list of products, or search for a specific product. The user can click on an individual product to zoom in on the detailed product information. A product is used when assembling a customer quote. The cases module may be accessed using a cases tab 140 and may permit the user to view a paginated list of cases, or search for a specific case. The user can click on an individual case to zoom in on the case information record and, from that detailed case record, the user can link to all related activities, see the activity history for the case, and link to related contacts. The cases are the handoff between the sales department and the customer support department and help customer support representatives manage support problems or inquiries to completion by tracking information for each case such as its status and priority, the user assigned, as well as a full trail of all related open and completed activities. A dashboard (such as that shown for example in FIG. 2B) module may be accessed using a dashboard tab 142 and permits the user to view a dashboard of the information in the CRM system.

The documents module may show the user a list of documents that the user can access, view and/or download. The user can also upload documents, assign publish and expiration dates, and specify which users can access them. The email module allows the user to write and send emails and to create Email Templates that can be used with email-based marketing campaigns. The user can also read, compose, save drafts, send and archive emails. The campaigns module helps the user implement and track marketing campaigns wherein the campaigns may be telemarketing, web banner, web tracker, mail or email based. For each Campaign, the user can create the Prospects list from the Contacts or Leads or outside file sources. The projects module helps the user manage tasks related to specific projects. Tasks can be assigned to different users and assigned estimated hours of effort and, as tasks are in progress and completed, users can update the information for each task. The RSS module permits the user to view the latest headlines provided by your favorite Really Simple Syndication (RSS) feeds. These feeds provide news or other web content that is distributed or syndicated by web sites which publish their content in this manner. The system has information on hundreds of RSS feeds available as supplied, and others may easily be added.

The forecasts module shows the user his/her committed forecast history and current opportunities. For managers, the user can view your team's rolled up forecasts. The reports module shows the user a list of saved custom reports not yet published, as well as a list of Published Reports. Saved reports may be viewed, deleted or published, and published reports may be viewed, deleted or un-published. Clicking on the name of a report zooms to the detailed definition of the report criteria (fields to be displayed, and filter settings) for that report, permitting the user to alter the criteria, and re-submit the report query. Finally, the dashboard module displays a graphical dashboard of the user's Opportunity Pipeline by Sales Stage, Opportunities by Lead Source by Outcome, Pipeline by Month by Outcome, and Opportunities by Lead Source. The system also supports users putting graphs from their reports directly on their dashboards.

Returning to FIG. 1A, the system also includes the database 110 that contains the data of the system and a security module 112 (row level security) that implements the security methods to control access to the data in the database 110 since the database is shared by all users of the system and the data must be segregated based on the users and their access level to different pieces of data. The system may also include a database abstraction layer 114 that is coupled between the database 110 and the SugarBean object 108 and acts as an interface between the database 110 and the SugarBean object 108. The SugarBean object 108 provides the base logic required for retrieving, making available and writing information to/from the database and each module creates subclasses of SugarBean (an example of which was described above) to provide module specific details, module specific data and module specific data views. During the process of retrieving data from the database, the SugarBean 108 makes calls that populate the row level security information into the SQL engine/database management system that retrieves the data.

Once the data is retrieved from the database by the SugarBean object 108, the module uses a template mechanism 118 and a theme 116 to produce the requested presentation (user interface) for the user. The template mechanism reformats the data from the database 110 into a particular form while the theme adjusts the user interface according to the user's preferences.

If, for instance, the user requests an HTML presentation of the detail view of the contact module for a specified contact, the system may perform that request as will now be described. The request of the user is directed to controller named index.php that handles most of the logic for the main application. The controller loads the current user information, verifies authentication and session information for the particular user session, loads the language for the user (based on the user preferences) and generates some of the user interface shell. The controller then calls the contact module and request the detail view for the specified contact. The contact module then retrieves the requested contact using the Sugarbean. The SugarBean verifies row level security for the requested contact at this point (with assistance from the security module 112. If the record is not retrieved successfully, then the process aborts and the user is not allowed to view the data for the record. If the retrieve process succeeds with the requested contact data, the Contact module uses the templating mechanism, such as for example XTemplate or Smarty, in the template mechanism 118 and the code for the current user's theme (retrieved by the theme module 116) is used to create the user interface for the presentation of the particular Contact data to the particular user. The resulting user interface then is sent back to the computing device with of client that requested it.

FIG. 1B illustrates more details of the customer relationship management system 100. Like elements shown in FIGS. 1A and 1B have like reference numerals. The system may interface with a typical browser application 103 (being executed by a computing device) that can access the system 100 over the web. For example, the examples of the user interface below are web-based views generated by the system and displayed on a browser application. The system may further comprise an application programming interface (APIs) portion 105, that may preferably use the well known simple object access protocol (SOAP), to interface with other existing system and applications. For example, the APIs may be used to interface to an email plug-in 109, such as an SugarCRM Plug-In for Microsoft Outlook®, that enhances the email program to allow it to interact with the system 100. As shown, the system 100, in one implementation, is implemented on a web server application 107 (that may be the well known Apache web server that includes IIS functionality) that generates dynamic web pages (using the known PHP language). The web server and the other elements of the system may be implemented as software running on one or more servers wherein the servers may use various different operating system as shown in FIG. 1B. The system 100 may also have an email module 111 capable of sending email via a local program (that may preferably be sendmail) or an email server leveraging the SMTP protocol.

A software application may include a quicknote functionality. In an exemplary embodiment, the quicknote functionality may be incorporated into the customer relationship management system shown in FIGS. 1A, 1B and 2 above and the quicknote functionality will be described with reference to the customer relationship management system although the quicknote functionality can be used with other systems and software applications or other web pages.

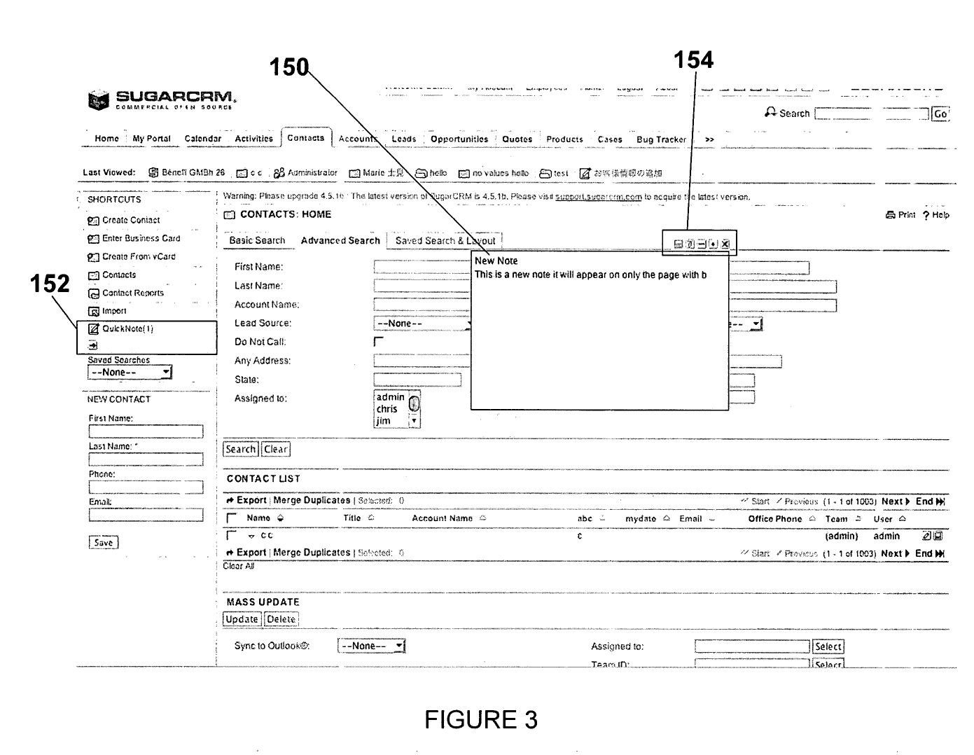

FIG. 3 illustrates an example of a quicknote 150 that appears on a user interface of the customer relationship management system application. The quicknote is a dynamic note that can be created on any web page and any web page may have zero or more quicknotes associated with the web page. The default quicknote allows a user to set a title for the note as well as a body of text/html (as shown in FIG. 3), but the note structure is a plugin-based structure that allows people to create their own note types. Some of these quicknote types could be an rss feed note as well as video feed note that allows users to share videos with other users. In the CRM system shown in FIG. 1A, the modules 106 may include a quicknote module that, in the exemplary embodiment, may be a plurality of lines of computer code that are executed by a processing unit that also executes the CRM application lines of computer code. The quicknote module may provide the quicknote functionality and generate the quicknotes described above and below.

Each quicknote (such as the exemplary quicknote shown in FIG. 3) may be able to be resized to any size and can be dragged anywhere on the page to a particular portion of the page. Once a quicknote is saved, it will keep those properties and appear in the same position whenever the page is loaded, unless the note has been dismissed or is hidden (put into a dismissed state or a hidden state that is stored in a data structure containing the quicknote). If a note has been dismissed, it will not be displayed on any user interface unless another user who is on the note replies to the note and then the note appears with the latest reply on top as described below in more detail. A dismissed note may use a fade animation to indicate to a user that it has been or is being dismissed. If a note is hidden, then the note is moved off-screen until the unhide button is pressed on a quick notes menu 152 on the left hand side of the screen as shown in FIG. 3. A user can either hide an individual note, all notes on the screen, or all notes in the system. When a user hides a note, the note may be animated as moving off the screen. If a user saves the note in a new position, the note will then appear in the new position when the web page/user interface is next loaded by the system. If a user wants the note to stay on the screen but take up less room, the user can collapse the note so only the title of the note appears. The user can collapse the note by clicking on a collapse button that may appear in a note menu 154 at the top of the note as shown in FIG. 3.

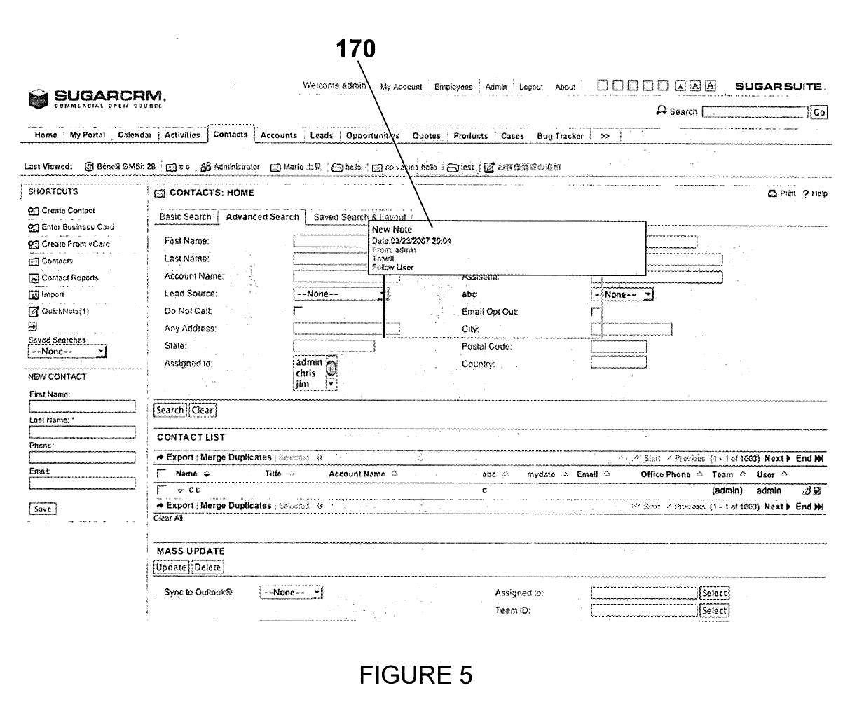

The note menu 154 has actions for saving, collapsing, hiding, dismissing, and flipping the note over for more information. If the user flips the note over, an animated action of the note flipping over may be shown to the user and, on a back 170 of the note, appears information (shown in FIG. 5) of who sent the note, who received the note, when it was created, when the newest reply was created and other properties of the note such as if it should follow users.

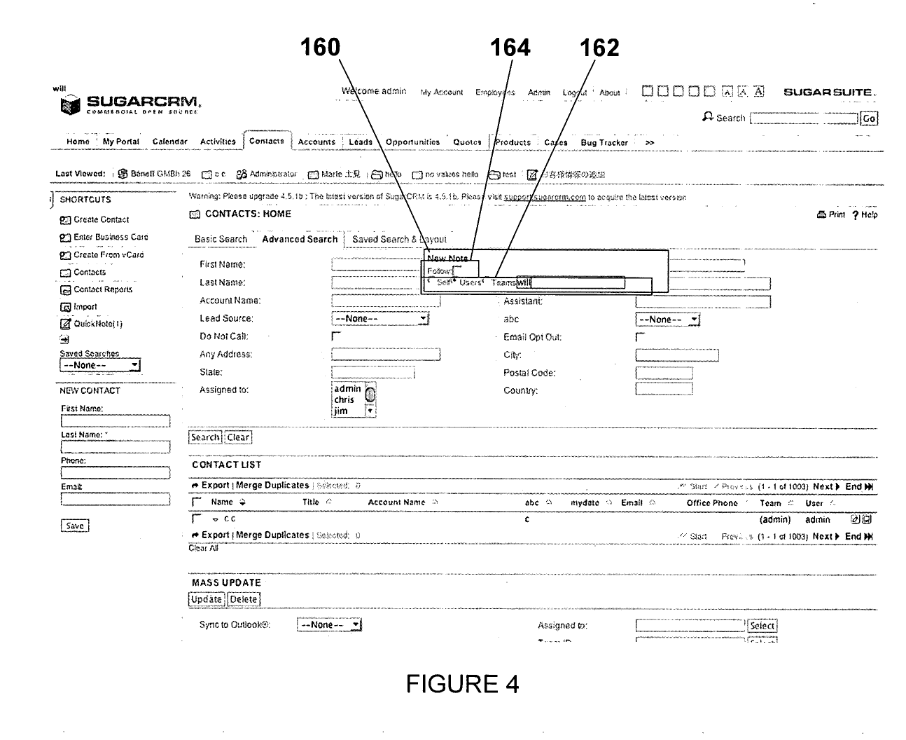

If a quicknote is being created, the quicknote module may allow a user to set the properties of the quicknote as shown in FIG. 4. A new note user interface 160 may be shown that allows the user to select (using a select menu 162) to whom the note is to be assigned. For example, the note can be assigned to the user (self), other users, or entire teams as shown. If a note is assigned to the user who created the note, it remains editable.

If it is assigned to another user, then both the original sender and the recipient have the ability to reply to that note. A reply becomes a page within the note with the newest reply on top and both the original sender and the original recipient will be able to view the note and the replies to the note. If a team or group is the recipient of the note, then everyone on the team at the time the note is sent will receive the note, and each one of those people on the team/group have the ability to reply to the note. In the exemplary embodiment, notes that are sent appear in one color (system or user defined) and notes that are received appear in another color to make it easy for a user to keep track of what is incoming and outgoing.

If a user wishes to use a quicknote as a notepad or wishes to send users something urgent they may use a follow me feature 164 which, when enabled, causes the note to appear on every page the user visits. The normal behavior of a quicknote, if “follow me” is not enabled, is for the quicknote to only appear on the page it was created on.

The quicknote module may also account for the age of a quicknote. For example, as a quicknote becomes older (each quicknote has a time from creation property), the quicknote color begins to fade and curled paper images are displayed in the corner of the note.

While the foregoing has been with reference to a particular embodiment of the invention, it will be appreciated by those skilled in the art that changes in this embodiment may be made without departing from the principles and spirit of the invention, the scope of which is defined by the appended claims.

1. A software application system, comprising:
a computing device with a processing unit;
an application having a plurality of lines of computer code wherein the plurality of lines of computer code are executed by the processing unit of the computing device to generate a user interface of the application wherein the user interface has a portion;
the application further comprising a quicknote module that is capable of generating one or more quicknotes associated with the portion of the application user interface; and
each quicknote having one or more members assigned to the quicknote, a title portion containing a title of the quicknote, a body portion containing content associated with the quicknote.

2. The system of claim 1, wherein each quicknote further comprises a reply portion capable of containing a reply to the quicknote from one or more members assigned to the quicknote.

3. The system of claim 1, wherein each quicknote further comprises a follow me functionality so that the quicknote follows the one or more members assigned to the quicknote across at least two portions of the user interface of the application.

4. The system of claim 1, wherein each quicknote further comprises a dismissed state wherein the quicknote fades out if the quicknote is in the dismissed state.

5. The system of claim 1, wherein each quicknote further comprises a hidden state wherein the quicknote does not appear on the user interface if the quicknote is in the hidden state.

6. The system of claim 1, wherein each quicknote further comprises a back portion wherein the quicknote is flipped over to reveal a set of information contained on the back portion.

7. The system of claim 6, wherein the set of information further comprises one or more of a quicknote originator who sent the quicknote, a quicknote recipient who received the quicknote, a quicknote creation time, a newest quicknote reply creation time indicating when a newest reply was created

8. The system of claim 1, wherein the set of information further comprises one or more properties of the quicknote.

9. The system of claim 1, wherein the application user interface further comprises a web page.

10. The system of claim 8, wherein the one or more properties of the quicknote further comprises a position of the quicknote on the application user interface.

11. The system of claim 8, wherein the one or more properties of the quicknote further comprises a compressed state wherein only the title of the quicknote is shown on the application user interface.

12. The system of claim 8, wherein the one or more properties of the quicknote further comprises a type of the quicknote wherein the type further comprises an RSS type quicknote and the content further comprises an RSS feed, a video type quicknote and the content further comprises a video piece of content or a picture type quicknote and the content further comprises a picture.

13. The system of claim 8, wherein the one or more properties of the quicknote further comprises a time from creation corresponding to a time period since the quicknote was created and a color fade wherein the quicknote fades as the time from creation is longer.

14. The system of claim 8, wherein the one or more properties of the quicknote further comprises a curling of the corners of the quicknote to indicate an old quicknote.

15. The system of claim 1, wherein the application is a customer relationship management application.

16. The system of claim 8, wherein the one or more properties of the quicknote further comprises a position of the quicknote on the webpage.

17. The system of claim 8, wherein the one or more properties of the quicknote further comprises a compressed state wherein only the title of the quicknote is shown on the web page.

18. The system of claim 8, wherein the one or more properties of the quicknote further comprises a type of the quicknote wherein the type further comprises an RSS type quicknote and the content further comprises an RSS feed or a video type quicknote and the content further comprises a video piece of content.

19. The system of claim 8, wherein the one or more properties of the quicknote further comprises a time from creation corresponding to a time period since the quicknote was created and a color fade wherein the quicknote fades as the time from creation is longer.

20. A method of providing a quicknote on a computing device with a processing unit that executes an application having a plurality of lines of computer code that are executed by the processing unit of the computing device, the method comprising:
generating a user interface of the application that has at least two portions;
generating one or more quicknotes associated with a portion of the user interface of the application wherein each quicknote has one or more members assigned to the quicknote, a title portion containing a title of the quicknote, a body portion containing content associated with the quicknote and a reply portion containing one or more replies to the quicknote from the one or more members assigned to the quicknote.

21. The method of claim 20 further comprising following, using the quicknote, the one or more members assigned to the quicknote across at least two portions of the user interface of the application.

22. The method of claim 20 further comprising fading out the quicknote if the quicknote is in a dismissed state.

23. The method of claim 20 further comprising hiding the quicknote on the user interface of the application if the quicknote is in a hidden state.

24. The method of claim 20 further comprising flipping over the quicknote to reveal a set of information contained on a back portion of the quicknote.
